(19) United States
(12) Patent Application Publication
(10) Pub. No.: US 2019/0018197 A1
(43) Pub. Date: Jan. 17, 2019

(54) PSEUDO GRADED-INDEX OPTICAL FOCUSING DEVICE

(71) Applicant: Commissariat A L'Energie Atomique et aux Energies Alternatives, Paris (FR)

(72) Inventors: Salim Boutami, Grenoble (FR); Karim Hassan, Moneteau (FR)

(73) Assignee: Commissariat A L'Energie Atomique et aux Energies Alternatives, Paris (FR)

(21) Appl. No.: 16/030,887

(22) Filed: Jul. 10, 2018

(30) Foreign Application Priority Data
Jul. 17, 2017 (FR) 17 56772

(51) Int. Cl. G02B 6/30; G02B 6/14; G02B 6/122

(52) U.S. Cl. CPC G02B 6/305; G02B 2006/12095; G02B 6/122; G02B 6/14

(57) ABSTRACT

The invention relates to an optical coupling device for coupling a first waveguide, for example a multi-mode waveguide, to a second waveguide, for example a single-mode waveguide. The device is formed in a core layer and comprises a focusing structure (SF) capable of converting a light beam from a target mode of the first waveguide to a target mode of the second waveguide. The focusing structure comprises a plurality of trenches (T1-T4) made in the core layer to create a pseudo graded refractive index, itself able to convert the light beam from the target mode of the first waveguide to the target mode of the second waveguide.

The scope of the invention extends to a photonic circuit comprising a single-mode waveguide, a multi-mode waveguide and a device according to the invention for coupling the single-mode waveguide to the multi-mode waveguide. The multi-mode waveguide can comprise a surface coupling network in order to allow for coupling with an optical fibre.

### TECHNICAL FIELD

The field of the invention is that of light guiding structures on micro- and nano-structured silicon used in photonics and optoelectronics. The invention more particularly relates to the production of a junction between a single-mode waveguide and a multi-mode waveguide, whereby such a junction is, for example, intended to allow light to be injected/extracted to/from the single-mode waveguide from/to an optical fibre by means of a surface coupling network integrated into the multi-mode waveguide.

### PRIOR ART

The on-chip propagation of optical signals requires a good compromise between losses and compactness. Depending on the target application, the total optical path length can vary from a few millimetres for a single function (emission, modulation, filtering, photodetection) to several centimetres for the most complex circuits. In this context, silicon photonics constitutes, in addition to the compatibility thereof with electronics, an extremely efficient platform thanks to the high index contrast between the core/cladding silicon/silica waveguides, which provides strong light confinement in small dimensions with very low linear propagation losses.

For longer circuits, the use of wide waveguides (exceeding the single-mode limit) results in optical loss savings of one order of magnitude. Moreover, the use of wide waveguides allows light to be extracted to optical fibres with a good coupling rate via a coupling network producing a mode size match between the fundamental mode of the waveguide and the mode of the fibre.

However, aside from these functions for which wide multi-mode waveguides are preferred, information processing (routing with quick turns, filtering, demultiplexing, resonators) essentially takes place using single-mode waveguides, which controls the interference processes and limits bending losses.

Junctions must thus be made, at several points in the chip, between single-mode waveguides and multi-mode waveguides in order to benefit from the advantages of each type of waveguide. The purpose of these junctions is to ensure that the multi-mode waveguide stays excited on the fundamental mode thereof (which is required in order to subsequently produce a new coupling to a single-mode waveguide, or to extract light to an optical fibre with a Gaussian profile), and is not excited on the upper modes thereof. However, such a junction without modification to the profile of the Gaussian mode requires a long length to prevent excitation of the upper modes of the multi-mode waveguide.

Adiabatic transitions are thus known, for example from the document [1] cited at the end of the description, to take place between a single-mode waveguide and a multi-mode waveguide that consist in a very slow variation in the width of a gradually-tapered waveguide from the single-mode waveguide to the multi-mode waveguide in order to stay on the fundamental mode of the multi-mode waveguide. Such transitions require a wavelength of about 500 μm for fibre coupling.

One alternative to these adiabatic transitions that is very specific to fibre coupling networks, consists of allowing the fundamental mode to diverge in order to widen the light beam, so as to reach a large size compatible with the fibre. In such a case, this is no longer on the fundamental mode, however the profile is substantially Gaussian. An elliptical coupling network is, however, required to extract the light since the wave front itself is elliptical. The gradually-tapered transition thus has a wavelength of about 50 μm for telecommunication applications. One example of such an alternative is, for example, disclosed in the document [2] cited at the end of the description.

Moreover, the document [3] cited at the end of the description proposes equipping a gradually-tapered waveguide with a lens allowing it to focus the fundamental mode of a multi-mode waveguide to the mode of a single-mode waveguide, and vice-versa. The lens is formed by etching between the two waveguides. This improves compactness, with a transition length of about 15 μm for telecommunications.

However, this aforementioned solution cannot be improved per se. More specifically, the lens has a radius R that is substantially equal to half of the width of the multi-mode waveguide. If looking to reduce this radius R, the area between the two guides must be etched further in order to deviate the light to a greater degree using a higher index contrast. However, this high index contrast would inevitably cause undesired reflections, and thus a reduced coupling rate.

This is why, in order to maintain a compromise between compactness and coupling rate, the focal length cannot be reduced below the width of the multi-mode waveguide, i.e. usually about 10 μm. By adding the radius of the lens to this focal length, the length of such a single-mode waveguide-multi-mode waveguide coupling device using a focusing lens is about 15 μm. In any case, using this approach, the overall length remains greater than the width of the multi-mode waveguide if looking to procure a good coupling rate.

### DESCRIPTION OF THE INVENTION

The purpose of the invention is to propose a coupling device for converting, over a short distance, light from the mode of a single-mode waveguide to the fundamental mode of a multi-mode waveguide, generally over a length that is less than the width of the multi-mode waveguide, while providing a high coupling rate.

For this purpose, the invention proposes an optical device for coupling a multi-mode waveguide to a single-mode waveguide. The device is formed in a core layer. It includes a focusing structure which comprises a plurality of trenches made in the core layer to create a pseudo graded refractive index, itself able to convert the light beam from a target mode of the multi-mode waveguide to the mode of the single-mode waveguide.

Some preferred, however non-limiting aspects of said device are described below:
it is symmetrical relative to a so-called central plane, perpendicular to the core layer, the intersection whereof with the core layer comprises a direction of light propagation, and each trench has a length along the direction of propagation and a width transverse to the direction of propagation, and wherein the width of the trenches is modulated from one trench to another;
the width of the trenches increases from one trench to another from the central plane;
the width of each trench is unvarying along the direction of propagation;
the trenches are made such that a local average refractive index of the focusing section decreases in the transverse plane in a parabolic manner from the central plane;
the trenches are arranged periodically in the transverse plane;
the core layer is made of a core material with a refractive index n_{c}, and the trenches have a refractive index n_{b} that is less than the refractive index n_{c} of the core layer;
the focusing section has a non-structured portion between one end of the trenches and the single-mode waveguide;
the focusing section is delimited by a periphery that has, in order, from the single-mode waveguide to the multi-mode waveguide, a first gradually-tapered part and a second constantly-tapered part;
the length of the focusing structure in the direction of propagation is less than the width of the multi-mode waveguide.

The scope of the invention extends to a photonic circuit comprising a multi-mode waveguide, a single-mode waveguide and an optical coupling device according to the invention for coupling the multi-mode waveguide to the single-mode waveguide. The multi-mode waveguide can comprise a surface coupling network with an optical fibre.

### BRIEF DESCRIPTION OF THE FIGURES

Other aspects, purposes, advantages and characteristics of the invention shall be better understood upon reading the following detailed description given of the non-limiting preferred embodiments of the invention, provided for illustration purposes, with reference to the appended figures, in which:

FIG. 1 is a diagrammatic, overhead view of an optical coupling device according to the invention;

FIG. 2 is a diagrammatic view, according to a transverse cutting plane, of the optical coupling device in FIG. 1;

FIG. 3 is a diagrammatic, overhead view of an optical coupling device according to one alternative embodiment of the invention;

FIG. 4 is a graph showing the evolution of the coupling rate of a device according to the invention as a function of the length of the focusing structure in the direction of propagation;

FIG. 5 shows the electromagnetic field distribution in a device according to the invention for coupling a single-mode waveguide having a width of 350 nm to a multi-mode waveguide having a width of 3 μm using a focusing structure having a length of 1.9 μm.

### DETAILED DESCRIPTION OF THE SPECIFIC EMBODIMENTS

The invention relates to a compact optical coupling device allowing for the effective coupling of a first waveguide (generally a multi-mode waveguide) to a second waveguide (generally a single-mode waveguide). The dimensions of the sections of the first and second waveguides, in a plane transverse to a direction of light propagation, are different. The first waveguide is, for example, wider than the second waveguide.

The invention boasts relevant applications in ensuring transitions to wide waveguides and over a plurality of wavelength ranges, thus satisfying the requirements of data communication/telecommunication applications (in infrared) and sensor applications (in medium- or broadband infrared) where the chip coverage area is even larger at long wavelengths.

One possible, however non-limiting application of the invention is that of the injection/extraction of light to/from a single-mode waveguide from/to an optical fibre using a surface coupling network integrated into a multi-mode waveguide.

The optical coupling device according to the invention is suitable for transmitting near-monochromatic light beam from the first waveguide to the second waveguide, and vice-versa. The term ‘near-monochromatic light beam’ is understood herein as light beam comprising an extended spectral band Δλ<λ/10 centred about a central wavelength λ. The central wavelength λ can lie in the range 1,260 nm to 1,360 nm, for example 1,310 nm, or in the range 1,530 nm to 1,580 nm, for example 1,550 nm.

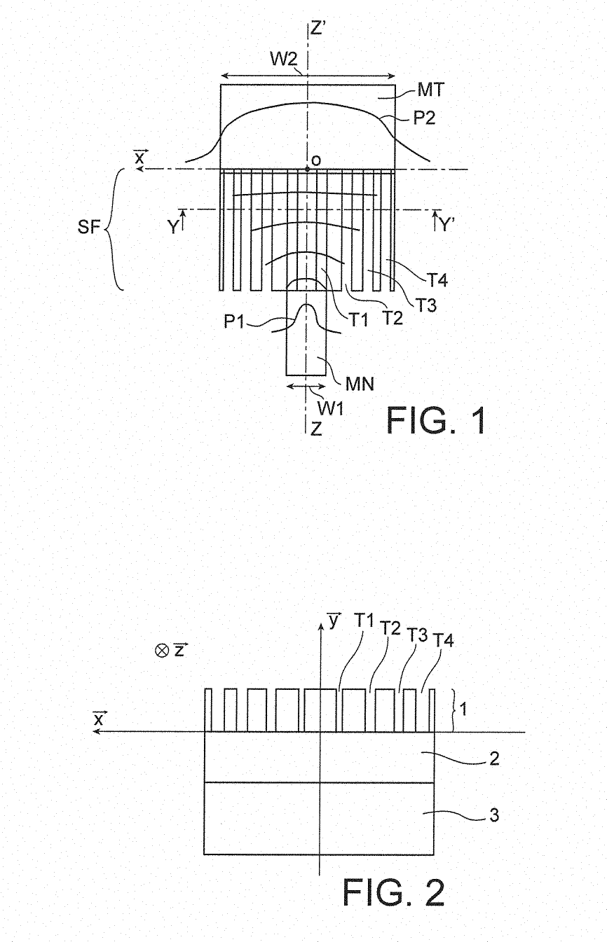

With reference to FIGS. 1 and 2, the optical coupling device according to the invention couples a first waveguide MT to a second waveguide MN using a focusing structure SF capable of converting a light beam from a target mode of the first waveguide to a target mode of the second single-mode waveguide, and vice-versa.

Without limiting the scope of the invention, the following description relates to the example of a first waveguide MT of the multi-mode waveguide type, and a second waveguide MN of the single-mode waveguide type. In such an example, the target mode of the first waveguide is one of the modes of the multi-mode waveguide, generally the fundamental mode thereof, and the target mode of the second waveguide is the mode (fundamental mode) of the single-mode waveguide.

Each of the waveguides MN, MT has, in the vicinity of the coupling thereof, a rectilinear section, whereby the rectilinear sections of the waveguides extend in a direction of light propagation Z-Z′.

The single-mode waveguide MN, the multi-mode waveguide MT and the focusing structure SF are formed in a core layer 1 that has a thickness Ec, and is made of a material with a refractive index n_{c} associated with an effective index of the planar core layer mode n_{eff}. The core layer 1 is a confinement layer for near-monochromatic light beam having a wavelength λ that is capable of being guided by the waveguides MN, MT and the optical coupling device.

The core layer 1 is, for example, a surface layer of a silicon-on-insulator (SOI) substrate. As shown in FIG. 2, the core layer 1 is thus separated from a silicon substrate 3 by a buried oxide layer 2. The thickness Ec of the core layer is, for example, 300 nm.

The core layer 1 comprises two faces, respectively referred to as the front face and the rear face, essentially parallel to one another, and in contact with media, the refractive index whereof is less than the refractive index nc. Returning to the example in FIG. 2, the rear face is in contact with the buried oxide layer 2, generally made of SiO₂, and the front face is in contact with the air.

The optical coupling device is symmetrical relative to a so-called central plane, perpendicular to the core layer 1, the intersection whereof with the core layer 1 comprises the direction of propagation Z-Z′. In the trihedral with a centre O and direction vectors \vec{x}, \vec{y} and \vec{z}, shown in FIG. 2 and where \vec{z} extends in the direction of propagation Z-Z′, the central plane corresponds to the plane (yOz), i.e. the plane passing through O and having the direction vectors \vec{y} and \vec{z}.

In a plane transverse to the central plane and perpendicular to the surfaces of the core layer (plane parallel to the plane (xOy) passing through O and having the direction vectors \vec{x}, \vec{y}), the single-mode waveguide MN extends over a distance (width) W1 and the multi-mode waveguide MT extends over a distance (width) W2 that is greater than the single-mode limit and thus greater than the width W1 of the single-mode waveguide MN. The width W1 of the single-mode waveguide MN is, for example, 350 nm and the width W2 of the multi-mode waveguide MT is, for example, 3 μm.

The focusing structure SF for the light is formed by the structuring of the core layer, for example at an end portion of the multi-mode waveguide abutted to the single-mode waveguide. It has a width in a plane transverse to the central plane and perpendicular to the surfaces of the core layer (plane parallel to the plane (xOy) passing through the focusing structure) that is at most identical (preferably identical as shown in FIG. 1) to the width W2 of the multi-mode waveguide MT.

The focusing structure SF comprises a region with a pseudo graded index derived from a structuring of the core layer 1. The term “pseudo graded index” is understood herein as meaning that the focusing structure does not comprise an actual refractive index variation profile for the core material as is the case for so-called “graded-index” structures, but that it has the same properties. Thus, during the passage thereof in the focusing structure, the light meets the equivalent of a focusing lens.

With such a region having a pseudo graded index, the light is deviated such that the light originating from the single-mode waveguide MN is focused on the multi-mode waveguide MT, and vice-versa. The pseudo graded index is such that the index decreases on either side of the central plane (yOz) in the transverse plane referenced Y-Y′ in FIG. 1. Thus, the average index is high as a whole in the centre, which slows the light, whereas it is lower on the sides, which accelerates the light.

In FIG. 1, the references P1 and P2 respectively denote the Gaussian profile of the single-mode waveguide MN and that of the fundamental mode of the multi-mode waveguide MT. The curves at the level of the focusing structure SF denote the evolution of the wave front (isophase lines) which, going from the multi-mode waveguide MT, gradually curve as the light propagates towards the single-mode waveguide while being slowed down at the centre and accelerated at the sides. The entirety of the light thus arrives at the same time and is focused on the single-mode waveguide. Preferably, a parabolic decrease in the refractive index is thus provided for on either side of the central plane.

The structuring of the core layer 1 to create the pseudo graded index consists in forming therein a plurality of trenches T1-T4 having a refractive index n_{b} that is less than the refractive index n_{c} of the material of the core layer 1. The difference between the refractive indexes of the core and of the trenches is preferably at least equal to 0.2.

Each trench has a depth (dimension along \vec{y}), a length (dimension along \vec{z}) and a width (dimension along \vec{x}). The trenches have the same depth. This depth is generally less than or equal to the thickness of the core layer. It can even be greater than the thickness of the core layer with trenches extending into the cladding.

The trenches can be exposed to air or filled with a filling material, for example SiO₂, having an index that is less than that of the material of the core layer.

The trenches T1-T4 are made in the core layer from the front face of the core layer perpendicular to the central plane, generally by etching. If the waveguides are of the ridge waveguide type, the trenches can be made at the same time as the formation of the ridge, in a single etching step. The depth thereof is thus less than the thickness of the core layer. They can also extend over the entirety of the core layer (with another etching step), be restricted to the ridge or also extend over the sides of the ridge. In the case of strip waveguides, the depth of the trenches can more easily correspond to the thickness of the core layer.

The trenches T1-T4 extend in the direction of propagation Z-Z′ such that the light propagates along the largest dimension of the trenches. The width of the trenches is modulated from one trench to another in the transverse plane Y-Y′. The width of the trenches more specifically increases from one trench to another from the central plane. As mentioned hereinabove, the trenches are made such that a local average refractive index of the focusing section decreases preferably in the transverse plane in a parabolic manner from the central plane.

The single-mode waveguide MN is preferably centred about a trench or a line of material of the core layer (an inter-trench space) depending on whether the number of lines is respectively even or uneven (see FIGS. 1 and 2).

In the embodiment shown in FIG. 1, the trenches have the same length L, i.e. the lines of material of the core layer (the inter-trench spaces corresponding to the non-etched portions of the core layer between two adjacent trenches) have the same length, regardless of whether said lines are thin (on the sides) or thick (in the centre).

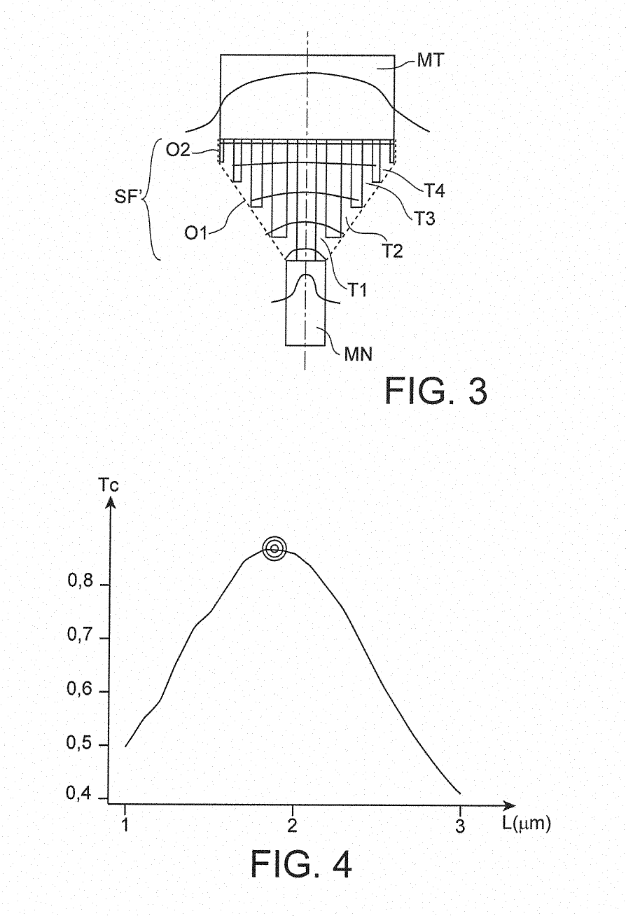

In one alternative embodiment shown in FIG. 3, the thin lines are shorter (in the Z-Z′ direction) than the thick lines. This does not affect the focusing function since, when going from the single-mode waveguide, the thin lines do not initially see the light. However, mechanical resistance is improved. In this alternative embodiment, the focusing section SF′ is delimited by a perimeter that has, according to a plane parallel to the surfaces of the core layer and, in order, from the single-mode waveguide to the multi-mode waveguide, a first gradually-tapered part O1 (the width of the focusing section increases in the direction of the multi-mode waveguide) and a second constantly-tapered part O2 (the width of the focusing section remains constant in the direction of the multi-mode waveguide).

The initial width of the first gradually-tapered part O1 is preferably greater than the width of the single-mode waveguide MN. More specifically, the mode of the single-mode waveguide extends laterally beyond the core, and such an initial width allows the entirety of the profile of the mode to benefit from the graded index.

The fundamental mode of the multi-mode waveguide MT does not overrun or only overruns to a small extent laterally, such that the width of the focusing section in the second constantly-tapered part O2 is preferably equal to the width W2 of the multi-mode waveguide, since there appears to be no advantage to providing a greater width.

In one possible embodiment, the focusing section has a non-structured portion between one end of the trenches and the single-mode waveguide. This non-structured portion can thus be a short region, for example less than 1μm in length, at which the lines, and in particular the thin lines, are joined together on the side of the single-mode waveguide. This embodiment has the advantage of providing improved mechanical resistance, without causing spurious reflections.

In another possible embodiment, the trenches are arranged periodically in the transverse plane Y-Y′ according to a pseudo-network with the period P (the centres of each inter-trench space are spaced apart by a distance P). This distance P is less than the wavelength λ, preferably less than λ/2 and more preferably less than λ/4.

With light focusing from the multi-mode waveguide to the single-mode waveguide, a light path of origin x on the axis O\vec{x} travels a distance \sqrt{L²+x²} and to equalise the journey times, the following approximative relation is produced (by approximating the index seen by the light travelling the distance \sqrt{L²+x²} as being the average

$$\frac{\tilde{n} ( x ) + \tilde{n} ( 0 )}{2} ) \text{:} \frac{2 π}{λ} ( \frac{\tilde{n} ( x ) + \tilde{n} ( 0 )}{2} ) \sqrt{{L}^{2} + {x}^{2}} = \frac{2 π}{λ} \tilde{n} ( 0 ) L ,$$

where ñ(x) is the average local index that only depends on x, since the trenches and the non-etched lines are unvarying in the direction of light propagation. The above relation is used to deduce the following:

$$\tilde{n} ( x ) = \tilde{n} ( 0 ) \frac{( 2 L - \sqrt{{L}^{2} + {x}^{2}} )}{\sqrt{{L}^{2} + {x}^{2}}} .$$

A relation between the average local index ñ(x) and the width e(x) of the non-etched lines is given by

$$\tilde{n} ( x ) = \sqrt{\frac{e ( x )}{P} {n}_{eff}^{2} + ( 1 - \frac{e ( x )}{P} ) {n}_{b}^{2}} ,$$

where n_{eff} refers to the effective index of the mode of the planar core layer and n_{b} refers to the index of the material of the trenches (which can be air).

This is used to deduce the law of symmetrical evolution, along x, of the width of the lines:

$$e ( x ) = \frac{[ e ( 0 ) . {n}_{eff}^{2} + ( P - e ( 0 ) ) . {n}_{b}^{2} ] * \frac{{( 2 L - \sqrt{{L}^{2} + {x}^{2}} )}^{2}}{{L}^{2} + {x}^{2}} - {Pn}_{b}^{2}}{{n}_{eff}^{2} - {n}_{b}^{2}} .$$

In the case of an uneven number of lines, e(0) (the width of the central line) can be set at the largest value technologically possible for etching a trench of width t1 such that P=e(0)+t1, then the length L can be adapted such that the thinnest lines of width e(W2/2) (=e(−W2/2)) also remain technologically feasible. By proceeding in this manner, the most compact focusing structure possible can be defined.

Such a law of evolution can be used to define an initial dimensioning, which can then be optimised by software, for example by using a so-called FDTD digital model (Finite Difference Time Domain Method).

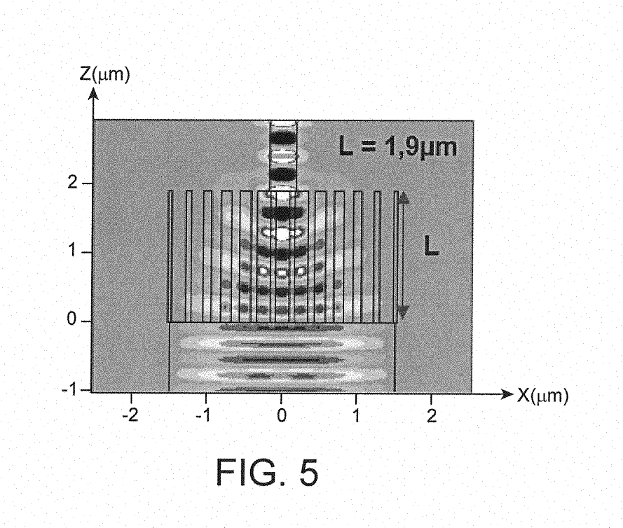

In order to estimate the performance levels, the behaviour of the optical coupling device according to the invention has been simulated in 3D according to such a FDTD digital model. In this simulation, the central wavelength is λ=1.31 μm, the pseudo-period of the network of trenches is P=250 nm, the multi-mode waveguide has a width of W2=3 μm and the single-mode waveguide has a width of W1=350 nm. The thickest central line has a width e(0)=0.8*P, whereas the smallest outer lines have a width e(W2/2)=0.2*P. The core layer is a layer of silicon with a thickness of 300 nm resting on a layer of SiO₂ of a SOI substrate. The trenches are exposed to air. The polarisation studied is TM (electric field oriented perpendicular to the plane in FIG. 5), associated with an effective index neff of 3.12.

In this simulation, the length L of the focusing structure has been varied in order to determine the appropriate length for optimal transition between the fundamental mode of the multi-mode waveguide and the mode of the single-mode waveguide (and vice-versa, as the coupling device evidently works in both directions). FIG. 4 thus shows the evolution of the coupling rate Tc as a function of the length L of the focusing structure. This FIG. 4 shows a very high coupling rate of 87% for a length L of less than 2 μm, whereas the multi-mode waveguide has a width of 3 μm. The invention thus achieves a level of compactness that is such that the length of the focusing structure is less than the width of the multi-mode waveguide.

As shown in FIG. 5, the device according to the invention is compact, while providing good transmission. More specifically, the light, when passing from the single-mode waveguide to the multi-mode waveguide, firstly sees the central line having a large width and thus a local index close to that of the single-mode waveguide, then only gradually spreads out to travel towards smaller local indexes. This reduction in the local index seen by the light is very gradual, which prevents reflections, unlike the lens described in the document [3]. It should be noted that with a multi-mode waveguide having a width of 10 μm, as is the case in the document [3], the optimal width of the focusing device according to the invention would be approximately 6.3 μm (1.9 μm*10/3), which is much less than the length of 16 μm mentioned in the document [3].

The invention is not limited to the aforementioned coupling device, however also extends to a photonic circuit comprising a first waveguide, a second waveguide and a device according to the invention for coupling the first waveguide to the second waveguide. The first waveguide can comprise a surface coupling network in order to allow for coupling with an optical fibre.

### REFERENCES

[1] D. Taillaert et al., “Grating Couplers for Coupling between Optical Fibers and Nanophotonic Waveguides”, Japanese Journal of Applied Physics 45.8R (2006)

[2] G. Denoyer et al., “Hybrid Silicon Photonic Circuits and Transceiver for 50 Gb/s NRZ Transmission Over Single-Mode Fiber”, Journal of Lightwave Technology 33.6 (2015)

[3] K. Van Acoleyen et al., “Compact lens-assisted focusing tapers fabricated on silicon-on-insulator”, IV Photonics (GFP), 2001, 8th IEEE, pp. 7-9 (2011)

1. An optical coupling device for coupling a multi-mode waveguide having a target mode to a single-mode waveguide having a fundamental mode, comprising a focusing structure capable of converting a light beam from the target mode of the multi-mode waveguide to the fundamental mode of the single-mode waveguide,
wherein the optical coupling device is formed in a core layer and
wherein the focusing structure comprises a plurality of trenches made in the core layer to create a pseudo graded refractive index capable of converting the light beam from the target mode of the multi-mode waveguide to the fundamental mode of the single-mode waveguide.

2. A device according to claim 1, symmetrical relative to a plane, called central plane, which is perpendicular to the core layer and which intersection with the core layer comprises a direction of light propagation, wherein each trench has a length along the direction of propagation and a width in a transverse plane to the direction of propagation, and wherein the width of the trenches is modulated from one trench to another.

3. The device according to claim 2, wherein the width of the trenches increases from one trench to another from the central plane.

4. The device according to claim 2, wherein the width of each trench is unvarying along the direction of propagation.

5. The device according to claim 3, wherein the trenches are made such that a local average refractive index of the focusing structure decreases in the transverse plane in a parabolic manner from the central plane.

6. The device according to claim 2, wherein the trenches are arranged periodically in the transverse plane.

7. The device according to claim 1, wherein the core layer is made of a core material with a refractive index n_{c}, and the trenches have a refractive index n_{b} that is less than the refractive index n_{c} of the core layer.

8. The device according to claim 1, wherein the focusing structure has a non-structured portion between one end of the trenches and the single-mode waveguide.

9. The device according to claim 1, wherein the focusing structure is delimited by a periphery that has, in order, from the single-mode waveguide to the multi-mode waveguide, a first gradually-tapered part and a second constantly-tapered part.

10. The device according to claim 1, wherein the length of the focusing structure in the direction of propagation is less than the width of the multi-mode waveguide.

11. A photonic circuit comprising a multi-mode waveguide, a single-mode waveguide and an optical coupling device according to claim 1 for coupling the multi-mode waveguide to the single-mode waveguide.

12. The photonic circuit according to claim 11, wherein the multi-mode waveguide comprises a surface coupling network.
